(19) United States
(12) Patent Application Publication
(10) Pub. No.: US 2026/0159246 A1
(43) Pub. Date: Jun. 11, 2026

(54) METHOD AND SYSTEM FOR CONTROLLING AN AIRCRAFT DISPLAY

(71) Applicant: AIRBUS HELICOPTERS, Marignane Cedex (FR)

(72) Inventors: Enrique LASO LEON, Toulouse (FR); Patrick FORTE, Marignane (FR); Alyson BRUEL, Cagnes-Sur-Mer (FR)

(73) Assignee: AIRBUS HELICOPTERS, Marignane Cedex (FR)

(21) Appl. No.: 19/179,214

(22) Filed: Apr. 15, 2025

(30) Foreign Application Priority Data
Jun. 18, 2024 (FR) FR2406477

(51) Int. Cl. B64D 43/00; G06F 3/01; G06F 3/02; G06F 3/03; G06F 3/0354; G06F 3/04842; G06F 3/04845

(52) U.S. Cl. CPC B64D 43/00; G06F 3/016; G06F 3/0202; G06F 3/0312; G06F 3/03549; G06F 3/04842; G06F 3/04845

(57) ABSTRACT

A control system for controlling a display, comprising a palm rest provided with a support face configured to receive a palm of a hand of an operator, two lateral faces situated on either side of the palm rest, and a front face. The control system also comprises four controls, namely a wheel projecting from one of the lateral faces, moveable relative to the palm rest along three non-coplanar axes, a push-button, a rotary ring positioned on the front face and able to rotate relative to the palm rest, a trackball, arranged at the center of the rotary ring and able to rotate relative to the palm rest about two complementary axes. Finally, the control system comprises a computer configured to generate control commands to control the display as a function of the actions on the four controls.

### CROSS REFERENCE TO RELATED APPLICATION

This application claims priority to French patent application No. FR 24 06477 filed on Jun. 18, 2024, the disclosure of which is incorporated in its entirety by reference herein.

### TECHNICAL FIELD

The present disclosure is in the field of display devices, and in particular those intended to equip aircraft.

### BACKGROUND

The present disclosure relates to a method and a system for controlling at least one display for an aircraft.

It is customary on computer equipment, for example a screen, to move a pointer, also referred to as a “cursor”, using control means, such as a mouse or a touch pad.

The appearance of screens provided with touch panels has introduced a new way of controlling and acting on the images displayed on such a screen, by pressing on the touch panel of this screen in order to perform the aforementioned actions. A touch panel also makes it possible to act on the displayed image, in particular by scrolling it, moving it or changing its scale, for example by movements carried out with two fingers.

Various displays, in particular screens, including screens with touch panels, are currently used in aircraft cockpits. Such displays make it possible, for example, to display a map that can thus be manipulated, moved or rotated.

However, the use of conventional control devices in an aircraft can be complex under certain flight conditions, especially in the presence of turbulence. This turbulence and/or vibrations of the aircraft may make the actions of an on-board operator to control and manipulate a control means imprecise, whether it is remote or formed by a touch panel of a screen.

Moreover, this difficulty may be aggravated by the need to use a restraint harness holding a pilot away from some displays. The relative position of a pilot and a display may possibly prevent the use of a touch panel.

Nevertheless, a pilot must be able to control a display regardless of the flight conditions and vibration environment of the aircraft.

For this purpose, a touch panel may be associated with a secondary control means, that remains accessible regardless of the flight conditions and the vibration environment of the aircraft.

For example, multi-point touch pads may be used. Nevertheless, such touch pads generally do not have a haptic system providing the operator with information relating to the manipulation carried out. In the case of a touch pad, haptic feedback can only be very generic, for example by the emission of vibrations at each action of the operator on the touch pad.

Document FR 3122934 describes a system for remote interaction with a cursor on a human-machine interface of an aircraft, this human-machine interface possibly comprising a plurality of screens. This interaction system comprises a hand-rest pommel and, in the extension of the hand-rest pommel, a touch pad. Control buttons can also be positioned on either side of the hand-rest pommel.

document FR 3122649 also describes a device for controlling a cursor of a graphical user interface for an aircraft. This control device comprises a base structure, a body that can be grasped by a hand of an operator, this body being able to move relative to the base structure, and a force sensor detecting the movements of the body relative to the base structure along two axes. An interface circuit converts the signals provided by the force sensor into a control signal for the graphical user interface in order to move the cursor over this graphical user interface. The body comprises raised areas, protrusions and bumps to improve its grip. The body also comprises a plurality of control components, such as buttons, levers and thumbwheels for example, positioned to be operated by the fingers of the hand of the operator in order to provide commands transmitted to a flight unit or for other units installed on the aircraft.

Document US 2003/0048252 describes a data entry device comprising a prominent hand rest of a fixing plate intended to be fixed to a workstation and a designator arranged on this plate, in front of the hand rest. The designator may, for example, be a sphere, a touch panel or a lever, and is capable of pointing to a position on a screen of a computer system. The hand rest extends mainly along a U-shaped arc, two buttons being positioned respectively on the faces located at the ends of this arc.

Documents US 2015/0286291, U.S. Pat. No. 5,561,445 and US 2012/0068928 are further from the disclosure.

An aim of the present disclosure is therefore that of providing an alternative and innovative solution for controlling an aircraft display that can be used by an operator regardless of the flight conditions and the vibration environment of the aircraft.

The present disclosure consists in providing a method and a system for controlling an aircraft display, that can be used whatever the flight conditions and the vibration environment of the aircraft, and in particular in the presence of turbulence. This method and system for controlling an aircraft display thus enable control of the display in order to move or modify an image displayed on this display as well as to move a pointer displayed on this display.

The present disclosure also relates to a display system comprising at least one display and such a control system.

### SUMMARY

Firstly, the present disclosure relates to a control system for controlling at least one display, the control system comprising a palm rest, fixed relative to a structure, the palm rest being provided with:
a support face configured to receive a palm of a hand of an operator;
two lateral faces, situated on either side of the palm rest, one of the two lateral faces being reachable by a thumb of the hand resting on the palm rest; and
a front face connecting the two lateral faces, and reachable by at least one other finger of the hand resting on the palm rest, or even by all the fingers of this hand.

The control system according to the disclosure comprises the following four controls:
at least one wheel projecting from one lateral face among said two lateral faces, said wheel being provided with at least three degrees of freedom, including at least one degree of freedom in rotation, with respect to the palm rest;
at least one push-button;
a rotary ring able to rotate relative to the palm rest about a main axis, the rotary ring being positioned on the front face;
a trackball, arranged at the center of said rotary ring and concentrically to the rotary ring, the trackball being able to rotate relative to the palm rest about two complementary axes, distinct from said main axis; and
a computer configured to generate control commands in order to control said display according to the actions on the four controls.

The palm rest makes it possible to support the palm of a hand of an operator, for example the pilot or co-pilot of a vehicle, for example an aircraft, on the support face, and thus to anchor this hand firmly. As a result, this hand is supported and held stably on the support face, regardless of the flight conditions and the vibration environment of the aircraft, and in particular in the presence of turbulence.

The four controls are positioned on the faces of the palm rest so as to be reached by the fingers of the hand in order to minimize the movements of the hand that can thus remain supported on the palm rest. In addition, the positioning of the four controls on the side and front faces of the palm rest naturally suggests how to use these controls with the different fingers of the hand.

For example, the wheel, positioned on a lateral face of the palm rest, can be manipulated by the index finger and thumb of the hand. This wheel is movable with respect to three axes, including a primary axis allowing rotation of the wheel on itself, and two additional axes distinct from the primary axis, these additional axes and the primary axis being non-coplanar. The wheel can rotate about each of the additional axes or move in translation along each of these additional axes.

The additional axes are, for example, parallel to a plane perpendicular to the primary axis. The primary axis of the wheel may constitute an axis of symmetry of the wheel.

The push-button, also positioned on a lateral face, can be manipulated by the index finger or thumb. The push-button can be manipulated with respect to a translation axis.

The rotary ring, positioned on the front face of the palm rest, can be manipulated by the index finger and thumb of the hand. The rotary ring is able to rotate relative to the palm rest about a main axis, that may, for example, be perpendicular to the front face or to a mid-plane of this front face.

The trackball, also positioned on the front face, can be manipulated by at least one finger of the hand, or even by all the fingers, for rotational movements of the trackball about the two complementary axes that are distinct from the main axis. These complementary axes and the main axis are non-coplanar, these complementary axes being, for example, parallel to a plane perpendicular to the main axis.

The operator can thus precisely act on all four controls with his fingers, under all flight conditions, including in the event of turbulence.

The computer is then configured to generate control commands in order to control the display as a function of the actions on the four controls and their respective movements with respect to the palm rest. Controlling the display may include moving a pointer, such as a cursor or arrow for example, displayed on the display, as well as controlling an image displayed on the display. This image may comprise, for example, a graphic representation of a map, one or more flight instruments or a view of the outside environment of the aircraft in particular. This image may include one or more symbols or icons. The control of an image may consist in movement of this image, in translation and/or in rotation, or a change of scale of this image. Finally, the control of the display may comprise selection of an area of the image or of a symbol, for example an icon, as well as a validation action, linked for example to a symbol or an icon.

The control system according to the disclosure thus advantageously groups together several mechanical interfaces in a single device, enabling precise and reliable control of the display and of a displayed image, minimizing the movements of the fingers of the hand of an operator, under all flight conditions, in particular in the event of turbulence.

The control system according to the disclosure may comprise one or more of the following features, taken individually or in combination.

According to one possibility, the wheel may include the push-button. For example, the push-button may be arranged at a free end of the wheel, in the gripping zone of this wheel. The translation axis of the push-button may, for example, be coincident with the primary axis of the wheel. In this case, the wheel has only three degrees of freedom, namely one degree of freedom in rotation about the primary axis and two degrees of freedom in translation or in rotation with respect to the two additional axes.

Alternatively, the wheel may form the push-button, the wheel being movable in translation along the primary axis that thus forms the translation axis of the push-button constituted by this wheel. In this case, the wheel has four degrees of freedom, including one degree of freedom in rotation about the primary axis and one degree of freedom in translation along the same primary axis, as well as two degrees of freedom in translation or in rotation with respect to the two additional axes.

According to another possibility compatible with the preceding possibilities, the lateral face comprising the wheel may comprise a lateral bulge configured to guide the thumb and an index finger of the hand towards the wheel. The thenar eminence of the hand, i.e., the part of the palm of the hand to which the thumb is connected, is supported on this lateral bulge. This lateral bulge can, firstly, facilitate access to the wheel for the thumb and index finger of the hand, and secondly obtain comfortable gripping of the wheel between the index finger and the thumb, both for rotation of the wheel on itself, about the primary axis, and for movement along the two additional axes.

For example, the lateral bulge may be elliptical in shape.

According to another possibility compatible with the preceding possibilities, the control system may comprise two wheels and two push-buttons, the two lateral faces each comprising one of the two wheels and one of the two push-buttons. The push-button and the wheel are thus duplicated symmetrically on each of the lateral faces of the palm rest, in order to allow ambidextrous use, in a similar way whether the operator is right-handed or left-handed.

According to another possibility compatible with the preceding possibilities, at least one of the four controls may comprise a haptic system in response to any motion or movement. Such a haptic system enables this control to provide the operator with haptic feedback following a movement of the control. This haptic feedback may, for example, comprise a force or resistance to the movement of the control, and cause the intended movement of the image or pointer on the display. This haptic feedback advantageously enables the operator to be provided with a sensitive response to his action on the control and contributes to increasing the precision of his gesture.

For example, the wheel comprises incrementation notches about its primary axis, mechanically marking a rotation of the wheel between two of these incrementation notches, these two incrementation notches being adjacent. The wheel comprises, for example, grooves parallel to the primary axis, these grooves being equally distributed in azimuth around this primary axis, and cooperating with one or more projecting elements of the palm rest or of a structural element of the palm rest. Conversely, the palm rest or a structural element of the palm rest may comprise such grooves parallel to the primary axis and equally distributed in azimuth about this primary axis, these grooves cooperating with one or more projecting elements of the wheel.

For example, the wheel may comprise elastic return elements that provide haptic feedback along the additional axes. These elastic return elements also help to return the wheel to an initial position along these additional axes. These elastic return elements may comprise, for example, one or more springs stressed in tension, compression or torsion.

In a similar way to the wheel, the rotary ring may comprise incrementation notches about the main axis, mechanically marking a rotation of the rotary ring between two incrementation notches, these two incrementation notches being adjacent. The rotary ring comprises, for example, grooves parallel to the main axis, these grooves being equally distributed in azimuth around this main axis, and cooperating with one or more projecting elements of the palm rest or of a structural element of the palm rest. Conversely, the palm rest or a structural element of the palm rest may comprise such grooves parallel to the main axis and equally distributed in azimuth about this main axis, these grooves cooperating with one or more projecting elements of the wheel.

Finally, the push-button may comprise one or more elastic return elements providing haptic feedback along the translation axis. This or these elastic return elements may contribute to returning the push-button to an initial position along the translation axis. For example, the one or more elastic return elements may comprise one or more tensile springs.

According to another possibility compatible with the preceding possibilities, the wheel may comprise a first code wheel about the primary axis and switches or strain gauges along the two distinct additional axes of the primary axis, in order to detect and measure the movements of the wheel about the primary axis and along the two additional axes, respectively. The trackball may comprise optical sensors to detect movements of the trackball about the two complementary axes while the rotary ring may comprise a second code wheel about the main axis.

The first and second code wheels, the switches or strain gauges and the optical sensors can then transmit measurement information relating to the movements of these controls, via the emission of digital or analog, electrical or optical signals, for the attention of the computer, to generate control commands transmitted to the display in order to move or modify the image displayed on the display.

According to another possibility compatible with the preceding possibilities, the computer may be configured to generate control commands transmitted to the display in response to control signals transmitted by the controls, in order to perform:
movement of a pointer displayed on the display as a function of a movement of the trackball;
a selection or validation action when the push-button is pressed;
modification of a display scale of an image displayed on the display as a function of a rotation of the wheel about the primary axis;
movement of the image as a function of a movement of the wheel along the two additional axes; and
rotation of the image as a function of a rotation of the rotary ring.

In this way, the control system according to the disclosure can control the display so as to fulfil the same functions as a conventional system provided with a touch panel, without having the drawbacks thereof. The operator can therefore adapt quickly to the control system according to the disclosure, while obtaining optimum stability and control precision, whatever the flight conditions and the vibration environment of the aircraft, and in particular in the presence of turbulence.

Moreover, the present disclosure also relates to a display system comprising at least one display, displaying an image and a pointer, or even one or more symbols, as well as a control system as previously described.

This display system constitutes a human-machine interface, capable of equipping a vehicle, for example an aircraft, and enabling control of the display, and in particular control and modification of the image displayed on the display, with stability and precision, using the four controls of the control system under all flight conditions, including in the event of turbulence.

Finally, the present disclosure also relates to a method of controlling at least one display using a control system as described above.

This method comprises the following steps carried out as a function of the actions on said at least one wheel, the push-button, the rotary ring and the control system trackball:
movement of a pointer displayed on the display as a function of a movement of the trackball;
selection or validation action when the push-button is pressed;
modification of a display scale of an image displayed on the display as a function of a rotation of the wheel about the primary axis;
movement of the image as a function of a movement of the wheel along the two additional axes; and
rotation of the image as a function of a rotation of the rotary ring.

The method according to the disclosure thus makes it possible to control the display, and in particular to control and modify the image displayed on the display as well as to move a pointer displayed on the display in a manner similar to conventional control devices, such as a touch panel for example, while obtaining stability and precision of control, under all flight conditions, including in the event of turbulence.

Moreover, when no pointer is displayed on the display, a first action on said at least one wheel, the push-button, rotary ring or trackball generates a display of the pointer on the display.

In this case, the pointer may be displayed on the display, either at a last position of the pointer on the display, or at a predetermined reference position. This predetermined reference position is, for example, the center of the display. The last position of the pointer on the display may have been saved in a memory of the computer.

Alternatively, when no pointer is displayed on the display, a contact on a touch panel of the display may enable the pointer to be displayed at that point of contact on the display.

In this way, the operator can move the pointer, following display of the pointer on the display.

In addition, this first action may be ignored in order to carry out the previously mentioned steps. More specifically, this first action, causing display of the pointer on the display, cannot be used to carry out another action. By way of illustration, the first rotation of the wheel causes display of the pointer, and not a modification to the scale of the displayed image.

### BRIEF DESCRIPTION OF THE DRAWINGS

The disclosure and its advantages appear in greater detail from the following description of examples given by way of illustration with reference to the accompanying figures, wherein:

FIG. 1 shows a control system according to the disclosure;

FIG. 2 shows a control system having a lateral bulge;

FIG. 3 shows gestures for manipulating the control system according to FIG. 1;

FIG. 4 shows gestures for manipulating the control system according to FIG. 1;

FIG. 5 shows gestures for manipulating the control system according to FIG. 1;

FIG. 6 shows gestures for manipulating the control system according to FIG. 1;

FIG. 7 shows gestures for manipulating the control system according to FIG. 1;

FIG. 8 shows a variant of the control system according to FIG. 1; and

FIG. 9 is a diagram illustrating a method for controlling at least one display, according to the disclosure.

### DETAILED DESCRIPTION

Elements present in more than one of the figures are given the same references in each of them.

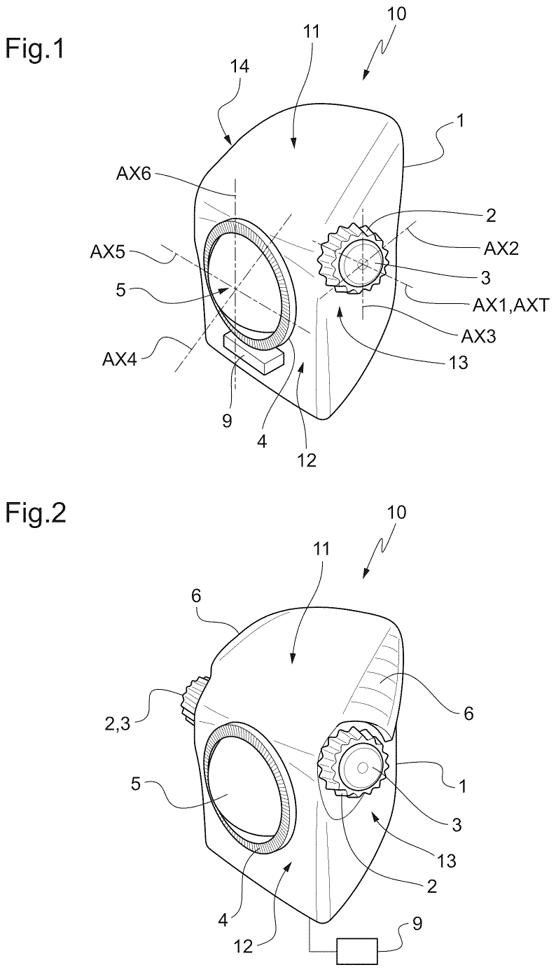

With reference to FIGS. 1 and 2, a control system 10 according to the disclosure comprises a palm rest 1, a computer 9 and four controls 2-5 positioned on the faces 11-14 of the palm rest 1. The four controls 2-5 are configured to control, via the computer 9, a display 30, and in particular an image displayed on this display 30 as well as a pointer displayed on this display. The control system 10 and the display 30 may together form a display system 20. Such a display system 20 can equip an aircraft, and in particular a cockpit of this aircraft. Alternatively, such a display system 20 may be arranged within any environment requiring driving of a cursor and an image. For example, such a display system 20 may be arranged within any type of vehicle, for example a tractor or a boat, that is also subject to sudden movements and vibrations.

Independently of the arrangement of the display system 20, the palm rest 1 is fixed relative to a structure, for example integral with the vehicle, and comprises a plurality of faces 11-14. The palm rest 1 has a support face 11 configured to receive a palm of a hand 50 of an operator. This support face 11 is, for example, oriented upwards when the control system 10 equips an aircraft resting on horizontal ground.

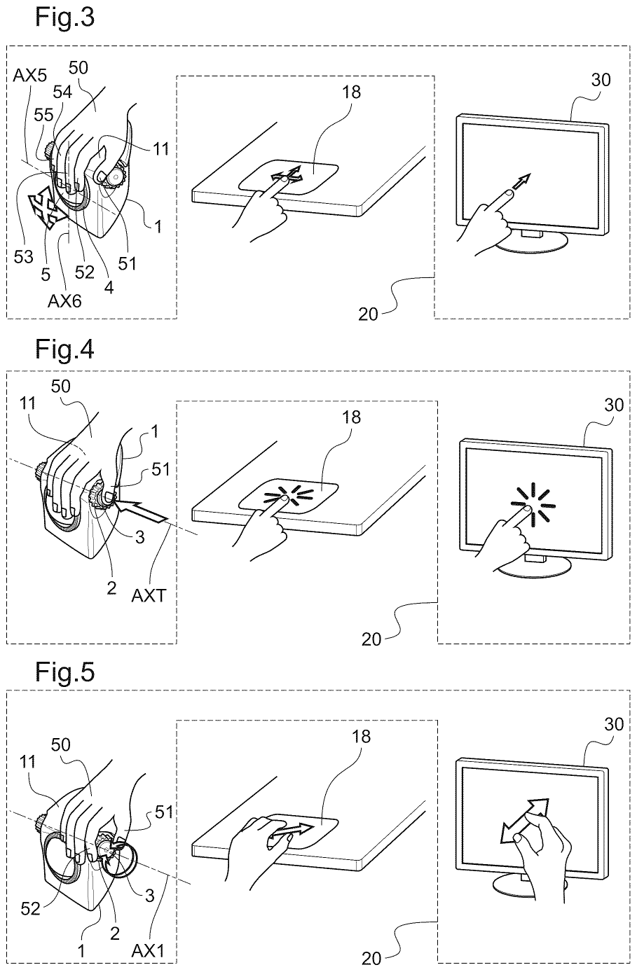

The palm rest 1 comprises two lateral faces 13, 14, adjacent to the support face 11 and situated on either side of the palm rest 1. One of these two lateral faces 13, 14 is reachable by a thumb 51 of the hand 50 resting on the palm rest 1. A first lateral face 13 is reachable by the thumb 51 of a right hand 50, as shown in FIG. 3. The second lateral face 14 opposite the first lateral face 13 is reachable by the thumb of a left hand. This second lateral face 14 can also be reached by the little finger of a right hand 50, the first lateral face 13 being reachable by the little finger of a left hand.

Finally, the palm rest 1 comprises a front face 12 connecting the two lateral faces 13, 14, and reachable by at least one finger 51-55 of the hand 50, the palm of that rests on the palm rest 1, or even by all the fingers 51-55 of this hand 50.

The four controls 2-5 of the control system 10 comprise, in particular, at least one wheel 2 projecting from one of the lateral faces 13-14. This wheel 2 has three degrees of freedom including at least one degree of freedom in rotation relative to the palm rest 1. The wheel 2 rotates about a primary axis AX1, allowing a rotation of the wheel 2 on itself without a stop, the wheel 2 thus being able to rotate indefinitely about this primary axis AX1. The wheel 2 also moves, to a limited extent, with respect to two additional axes AX2, AX3 that are distinct and not parallel to the primary axis AX1. The wheel 2 can, for example, move in translation along the two additional axes AX2, AX3, or alternatively in rotation about these two additional axes AX2, AX3.

The two additional axes AX2, AX3 are not parallel to one another, and may, for example, be parallel to a plane perpendicular to the primary axis AX1. The two additional axes AX2, AX3 may optionally be coplanar. Moreover, the primary axis AX1 may be perpendicular to the lateral face 13, 14 on which the wheel 2 is arranged, if this lateral face 13, 14 is substantially flat, or perpendicular to a median plane of this lateral face 13, 14.

The control system 10 may, for example, comprise a single wheel 2 arranged on the first lateral face 13, and reachable by the thumb 51 and the index finger 52 of a right hand 50. Alternatively, the control system 10 may comprise a single wheel 2 arranged on the second lateral face 14 and reachable by the thumb and index finger of a left hand.

Alternatively and as illustrated in FIG. 2, the control system 10 may comprise two wheels 2 arranged respectively on the two lateral faces 13-14.

The control system 10 also comprises at least one push-button 3, also positioned on one of the lateral faces 13-14 where the wheel 2 is arranged. The push-button 3 can be actuated in translation by the index finger 52 or the thumb 51 of the hand 50 placed on the support face 11, along a translation axis AXT. Like the wheel 2, the control system 10 may, for example, comprise a single push-button 3 positioned on one of the lateral faces 13-14 so as to be manipulable either by a right hand 50 or by a left hand, or may alternatively comprise two push-buttons 3 positioned respectively on the two lateral faces 13-14, each of the two push-buttons 3 then being manipulable respectively by the thumb 51 or the index finger 52 of a right or left hand 50.

The wheel 2 may comprise the push-button 3, that is arranged for example at one end of the wheel 2. The translation axis AXT of the push-button 2 may in this case be coincident with the primary axis AX1 of the wheel 2.

Alternatively, the wheel 2 may form the push-button 3. The wheel 2 is then moveable in translation as a whole along the translation axis AXT of the push-button 3, that is then coincident with the primary axis AX1 of the wheel 2. In this case, the wheel 2 has four degrees of freedom, including one degree of freedom in rotation and one degree of freedom in translation along the same primary axis AX1.

The control system 10 also comprises a rotary ring 4 positioned on the front face 12 and rotatable relative to the palm rest 1 about a main axis AX4 allowing rotation of the rotary ring 4 on itself without a stop. The rotary ring 4 may be connected to the palm rest 1 by a pivot connection. The main axis AX4 may be perpendicular to the front face 12 if this front face 12 is substantially flat, or to a median plane of this front face 12.

Finally, the control system 10 comprises a trackball 5 positioned on the front face 12, and arranged at the center of the rotary ring 4 and concentrically to the rotary ring 4. The trackball 5 is rotatable relative to the palm rest 1 about two complementary axes AX5, AX6 distinct from the main axis AX4, the two complementary axes AX5, AX6 and the main axis AX4 being non-coplanar. The two complementary axes AX5, AX6 are not parallel to each other, and may for example be parallel to a plane perpendicular to the main axis AX4. The two complementary axes AX5, AX6 are coplanar. The trackball 5 may be connected to the palm rest 1 by a universal joint or by two pivot joints.

With reference to FIG. 2, the control system 10 may comprise, on the lateral face 13, 14 comprising the wheel 2, a lateral bulge 6 configured to guide the thumb 51 and the index finger 52 of the hand 50 towards the wheel 2, and the push-button 3 when this push-button 3 is positioned on the wheel 2 or is formed by the wheel 2. The lateral bulge 6 thus facilitates the gripping of the wheel 2 jointly with the thumb 51 and the index finger 52 of the hand 50. The operator can thus:
rotate the wheel 2 on itself about the primary axis AX1, by moving the index finger 52 and the thumb 51 tangentially in opposite directions;
move the wheel 2 along the additional axis AX2 by extending or retracting the index finger 52 and thumb 51 simultaneously and similarly; and
move the wheel 2 along the additional axis AX3 by pushing on either the thumb 51 or the index finger 52.

The lateral bulge 6 may be, for example, elliptical in shape in order to intuitively and comfortably guide the thumb 51 and the index finger 52 of the hand 50 towards the wheel 2 and the push-button 3.

In addition, the control system 10 may comprise, in the usual way, measuring devices in order to measure the movements of the controls 2-5. For example, the control system 10 may comprise a first code wheel, also referred to as a “rotary encoder”, associated with the wheel 2 and movable about the primary axis AX1 in order to detect and/or measure the movements of the wheel 2 about this primary axis AX1. For example, the first code wheel may be an optical code wheel. The control system 10 may also comprise switches or strain gauges along the two additional axes AX2, AX3, associated with the wheel 2, for detecting and/or measuring the movements of the wheel 2 along the two additional axes AX2, AX3, respectively.

Similarly, the control system 10 may comprise a second code wheel associated with the rotary ring 4 and movable about the main axis AX4 in order to detect and/or measure the movements of the rotary ring 4 about this main axis AX4. For example, the second code wheel may be an optical code wheel.

The control system 10 may comprise a switch associated with the push-button 3 in order to detect pressing of the push-button 3 along the translation axis AXT.

Finally, the control system 10 may comprise optical sensors associated with the trackball 5 for detecting and/or measuring the movements of the trackball 5 about the two complementary axes AX5, AX6.

Moreover, one or more of the four controls 2-5 may comprise a haptic system.

For example, the wheel 2 may comprise incrementation notches about the primary axis AX1, mechanically marking, by a hard point requiring a slight manipulation force to be exceeded, a rotation of the wheel 2 between two incrementation notches. These incrementation notches allow the operator to feel the rotation of the wheel 2 about the primary axis AX1, advantageously attenuating the tendency to move beyond the desired position. These incrementation notches may in particular be associated, or even integrated, with a first code wheel, if applicable.

Similarly, the rotary ring 4 may also have incrementation notches about the main axis AX4, mechanically marking a rotation of the rotary ring 4 between two of the incrementation notches. These incrementation notches may in particular be associated, or even integrated, with a second code wheel, if applicable.

Finally, the push-button 3 and the wheel 2 may respectively comprise one or more elastic return elements to return them to an initial position. For example, these elastic return elements may comprise one or more springs.

The initial positions of the push-button 3 and the wheel 2, also called “neutral positions”, are the positions wherein the push-button 3 and the wheel 2 are respectively located, when no force or action is exerted on them. This or these elastic return elements thus allow the push-button 3 and the wheel 2 respectively to return autonomously and automatically to their initial position after any movement, when no force or action is any longer exerted on them, namely when the push-button 3 and the wheel 2 are not moved or held in position by the operator.

The computer 9 is configured to generate control commands in order to control the display 30 based on the actions on the four controls 2-5. These control commands are generated in response to control signals transmitted by the controls 2-5, or even by the measuring devices associated with these controls 2-5. The computer 9 may be connected to the controls 2-5, or even directly to the measuring devices associated with these controls 2-5, as applicable.

These control commands are then transmitted to the display 30, via signals referred to, for convenience, as “command signals”. The control signals and the command signals may be electrical or optical, digital or analog signals, respectively bearing the one or more movements of the controls 2-5 and one or more control commands. Control signals and command signals may be transmitted over wired or wireless connections.

A memory of the computer 9 or connected to the computer 9, by wired or wireless means, may for this purpose comprise control laws transforming any movement of these controls 2-5 into a control command. The four controls 2-5 are thus configured to control the display 30, via the control commands generated by the computer 9, for example to move or modify an image displayed on the display 30, to move a pointer displayed on the display 30, to perform a selection on the display 30 or a validation action.

The computer 9 may have one or more processing units comprising, for example, at least one processor and at least one memory, at least one integrated circuit, at least one programmable system, at least one logic circuit, these examples not limiting the scope given to the expression “processing unit”. The term “processor” may be used equally well to mean a central processing unit (CPU), a graphics processing unit (GPU), a digital signal processor (DSP), a microcontroller, etc.

These control commands thus make it possible to perform a plurality of actions in order to control the display 30. The movements of the controls 2-5 of the control system 10 according to the disclosure make it possible to obtain the same effects as the gestures usually performed to control a display using a touch pad 18, as shown in FIGS. 3 to 7. These movements of the controls 2-5 are carried out while placing the palm of this hand 50 on the support face 11 of the palm rest 1, advantageously minimizing the movements of the fingers 51-55 of the hand of an operator 50, whatever the flight conditions, in particular in the event of turbulence.

When one or more fingers 51-55 of the hand 50 move the trackball 5 tangentially along one or both of the complementary axes AX5, AX6, as shown in FIG. 3, the computer 9 is configured to generate a control command generating a movement of a pointer 35 displayed on the display 30 as a function of the movement of the trackball 5.

When the thumb 51 presses the push-button 3 along the translation axis AXT, as shown in FIG. 4, the computer 9 is configured to generate a control command relating to an action of selecting a symbol, for example an icon, displayed on the display 30 or an area of the image displayed on the display 30, or a validation action via a symbol.

When the thumb 51 and the index finger 52 of the hand 50 rotate the wheel 2 about its primary axis AX1 on itself, as shown in FIG. 5, the computer 9 is configured to generate a control command generating a modification of a display scale of an image displayed on the display 30 as a function of this rotation of the wheel 2. This modification makes it possible, for example, to zoom in or out on a map displayed on the display 30.

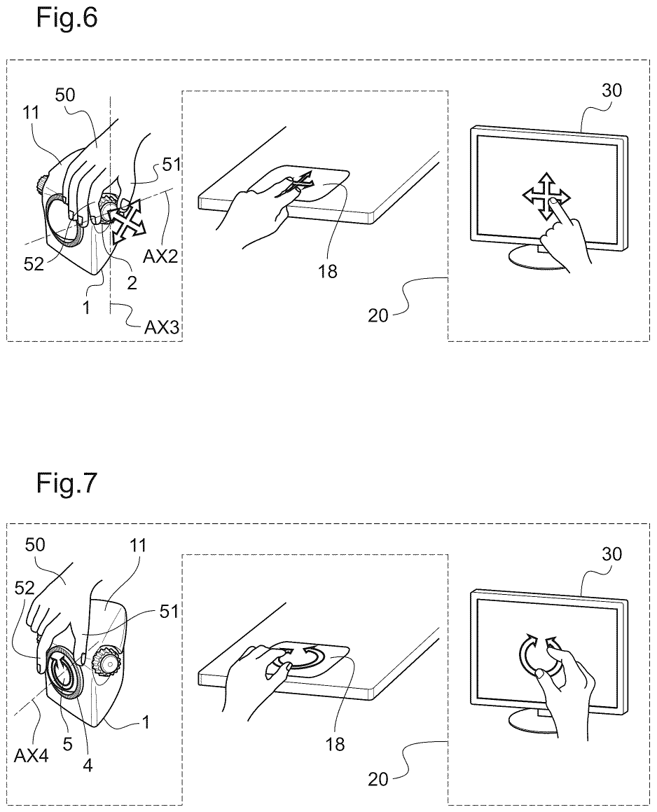

When the thumb 51 and/or the index finger 52 of the hand 50 move the wheel 2 along one or both of the additional axes AX2, AX3, as shown in FIG. 6, the computer 9 is configured to generate a control command generating a movement of the image displayed on the display 30 as a function of this movement of the wheel 2. This movement may thus be obtained by applying to the wheel 2, with the aid of the thumb 51 and/or the index finger 52, a pushing or pulling movement along one of the two additional axes AX2, AX3, for example substantially vertically, or a lateral movement along the other additional axis AX2, AX3, for example substantially horizontally, as shown in FIG. 6. This movement makes it possible, for example, to move a map displayed on the display 30.

Finally, when the thumb 51 and/or the index finger 52 of the hand 50 move the rotary ring 4 about the main axis AX4, as shown in FIG. 7, the computer 9 is configured to generate a control command generating a rotation of the image displayed on the display 30 as a function of such a rotation of the rotary ring 4. This rotation makes it possible, for example, to rotate on itself a map displayed on the display 30 about an axis perpendicular to a plane defined by the display 30.

In addition, the computer 9 may be configured so as not to generate a plurality of control commands simultaneously. In this way, when a first command 2-5 is requested by an operator, the computer 9 generates a command order to control the display 30 as a function of this request. If the operator requests a second command 2-5 in parallel, no command order relating to this second command 2-5 is emitted, the computer 9 only generating a command order relating to the first command 2-5 requested.

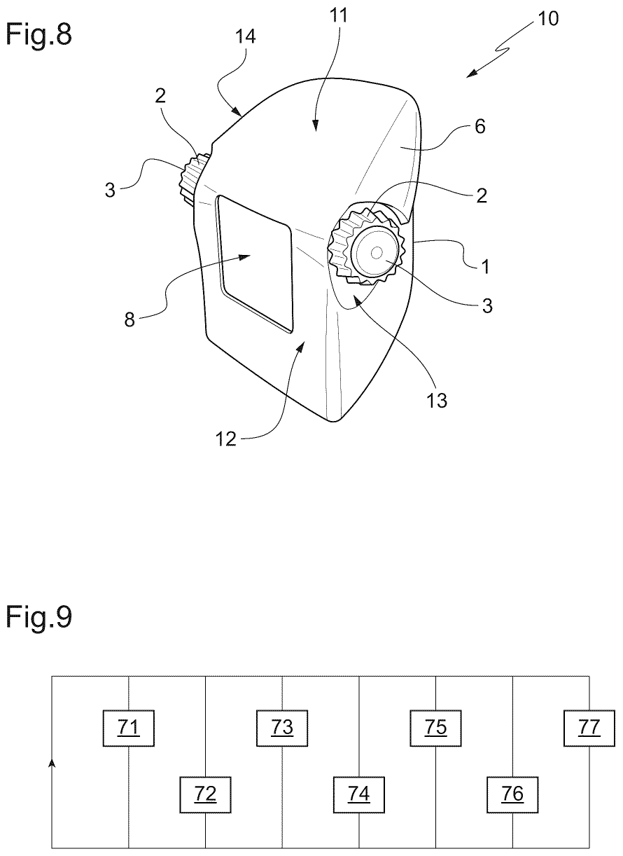

Furthermore, the rotary ring 4 and the trackball 5 may be replaced by a touch pad 8 arranged on the front face of the palm rest 1, as shown in FIG. 8. The gestures used by the operator to control the display 30 are advantageously identical whether the control system 10 according to the disclosure comprises the rotary ring 4 and the trackball 5 or the touch pad 8.

The present disclosure also relates to a method for controlling at least one display 30 using the control system 10. A memory of the computer 9, or connected to the computer 9 by wired or wireless means, may for example store instructions or algorithms executed by the computer 9 in order to implement the control method of the disclosure. The memory may also store a computer program intended to be run by the computer 9 in order to implement such a control method.

This control method comprises the following steps illustrated in FIG. 9. These steps are carried out as a function of the actions on said at least one wheel 2, the push-button 3, rotary ring 4 and trackball 5 of the control system 10.

Firstly, a movement 71 of a pointer 35 displayed on the display 30 can be carried out as a function of a movement of the trackball 4 along the two complementary axes AX5, AX6, performed using one or more fingers 51-55 of the hand 50.

An action of selecting 72 an icon or a symbol displayed on the display 30 or an area on the image displayed on the display 30 or an action or validation 73 via an icon or a symbol can be carried out when the push-button 3 is pressed along a translation axis AXT by means of the thumb 51.

A modification 74 of a scale for displaying an image displayed on the display 30 may also be carried out as a function of a rotation of the wheel 2 about a primary axis AX1 allowing a rotation of the wheel 2 on itself, using the thumb 51 and the index finger 52 of the hand 50.

A movement 75 of the image may also be carried out as a function of a movement of the wheel 2 along the two additional axes AX2, AX3 carried out using the thumb 51 and/or the index finger 52.

Finally, a rotation 76 of the image may be produced as a function of a rotation of the rotary ring 4 about a main axis AX4, carried out by means of the thumb 51 and the index finger 52.

All these steps of the control method are advantageously carried out by holding the palm of this hand 50 on the support face 11 of the palm rest 1, in order to minimize the movements of the fingers 51-55 of the hand of an operator 50, while guaranteeing precise and safe gestures, under all flight conditions, including in the event of turbulence.

In addition, when no pointer 35 is previously displayed on the display 30, in response to a first action on the wheel 2, the push-button 3, rotary ring 4 or trackball 5, the computer 9 may be configured to transmit a signal to the display 30 in order to display 77 the pointer 35 on the display 30. This first action advantageously enables the operator to make the pointer 35 appear on the display 30.

During this display step 77, the pointer 35 can be displayed on the display 30 either at a last display position of the pointer 35 on the display 30, or at a predetermined reference position. This predetermined reference position is, for example, the center of the display. The last display position of the pointer 77 on the display 30 as well as the reference position may have been stored in a memory of the computer 9 or in a memory connected to this computer 9.

Finally, the first action may be taken into account by the computer 9 only for the display 77 of the pointer 35 on the display 30 and may not cause one of the aforementioned steps 71-76 to be carried out. This first action is then ignored for carrying out one of these steps 71-76 in order, in particular, to avoid carrying out unintentional and/or undesired operations. On the other hand, if the pointer 35 is displayed on the display 30, any action on one of the controls 2-5 causes the generation of a command order to carry out one of these steps 71-76, in order to control the image displayed on the display 30.

Naturally, the present disclosure may be subjected to numerous variations as to its implementation. Although several embodiments are described above, it should readily be understood that it is not conceivable to identify exhaustively all the possible embodiments. It is naturally possible to envisage replacing any of the means described by equivalent means without going beyond the ambit of the present disclosure.

What is claimed is:

1. A control system for controlling a display, the control system comprising a palm rest, fixed relative to a structure, the palm rest being provided with:
a support face configured to receive a palm of a hand of an operator;
two lateral faces situated on either side of the palm rest, one of the two lateral faces being reachable by a thumb of the hand resting on the palm rest; and
a front face reachable by at least one other finger of the hand resting on the palm rest,
wherein the control system comprises the following four controls:
at least one wheel projecting from one lateral face among the two lateral faces, the wheel being provided with at least three degrees of freedom, including at least one degree of freedom in rotation, with respect to the palm rest;
at least one push-button;
a rotary ring able to rotate relative to the palm rest about a main axis, the rotary ring being positioned on the front face;
a trackball, arranged at the center of the rotary ring and concentrically to the rotary ring, the trackball being able to rotate relative to the palm rest about two complementary axes distinct from the main axis; and
a computer configured to generate control commands to control the display according to the actions on the four controls.

2. The control system according to claim 1,
wherein the wheel includes the push-button, the wheel having three degrees of freedom.

3. The control system according to claim 1,
wherein the wheel forms the push-button, the wheel having four degrees of freedom, including one degree of rotational freedom and one degree of translational freedom along a primary axis allowing rotation of the wheel on itself.

4. The control system according to claim 1,
wherein the control system comprises two wheels and two push-buttons, the two lateral faces each comprising one of the two wheels and one of the two push-buttons.

5. The control system according to claim 1,
wherein the lateral face comprising the wheel comprises a lateral bulge configured to guide the thumb and an index finger of the hand towards the wheel.

6. The control system according to claim 1,
wherein at least one of the four controls comprises a haptic system in response to any movement.

7. The control system according to claim 6,
wherein the wheel comprises a primary axis allowing rotation of the wheel on itself and comprises incrementation notches about the primary axis, mechanically marking a rotation of the wheel between two of the incrementation notches.

8. The control system according to claim 6,
wherein the rotary ring comprises incrementation notches about the main axis, mechanically marking a rotation of the rotary ring between two of the incrementation notches.

9. The control system according to claim 1,
wherein the push-button and the wheel respectively comprise elastic return elements to return them to an initial position.

10. The control system according to claim 1,
wherein the wheel has a primary axis allowing rotation of the wheel on itself, the wheel comprising a first code wheel about the primary axis and switches or strain gauges along two additional axes distinct from the primary axis for detecting movements of the wheel about the two additional axes, the trackball comprising optical sensors for detecting movements of the trackball about the two complementary axes and the rotary ring having a second code wheel about the main axis.

11. The control system according to claim 1,
wherein the controls are configured to move or modify an image displayed on the display, to move a pointer displayed on the display, to perform a selection on the display, or to perform a validation action.

12. The control system according to claim 1,
wherein the computer is configured to generate control commands transmitted to the display in response to control signals transmitted by the controls in order to perform:
a movement of a pointer displayed on the display as a function of a movement of the trackball along the two complementary axes;
a selection or validation action when the push-button is pressed;
a modification of a display scale of an image displayed on the display as a function of a rotation of the wheel about a primary axis allowing a rotation of the wheel on itself;
a movement of the image as a function of a movement of the wheel along two additional axes distinct from the primary axis; and
a rotation of the image as a function of a rotation of the rotary ring about the main axis.

13. A display system comprising at least one display displaying an image comprising a pointer and the control system according to claim 1.

14. A vehicle comprising at least one display displaying an image comprising a pointer and the control system according to claim 1.

15. A method for controlling at least one display using the control system according to claim 1,
the method comprising the following steps carried out as a function of the actions on the at least one wheel, the push-button, the rotary ring and the trackball of the control system:
a movement of a pointer displayed on the display as a function of a movement of the trackball along the two complementary axes;
a selection or validation action when the push-button is pressed;
a modification of a display scale of an image displayed on the display as a function of a rotation of the wheel about a primary axis allowing a rotation of the wheel on itself;
a movement of the image as a function of a movement of the wheel along two additional axes distinct from the primary axis; and
a rotation of the image as a function of a rotation of the rotary ring about the main axis.

16. The method according to claim 15,
wherein when no pointer is displayed on the display, a first action on the at least one wheel, the push-button, the rotary ring or the trackball generates a display of the pointer on the display.

17. The method according to claim 16,
wherein the pointer is displayed on the display at either a last position of the pointer on the display or at a predetermined reference position.

18. The method according to claim 16,
wherein the first action is ignored for carrying out the following steps carried out as a function of the actions on the at least one wheel, the push-button, the rotary ring and the trackball of the control system:
a movement of a pointer displayed on the display as a function of a movement of the trackball along the two complementary axes;
a selection or validation action when the push-button is pressed;
a modification of a display scale of an image displayed on the display as a function of a rotation of the wheel about a primary axis allowing a rotation of the wheel on itself;
a movement of the image as a function of a movement of the wheel along two additional axes distinct from the primary axis; and
a rotation of the image as a function of a rotation of the rotary ring about the main axis.
